(19) United States
(12) Patent Application Publication
(10) Pub. No.: US 2006/0263116 A1
(43) Pub. Date: Nov. 23, 2006

(54) Storage vessel and image forming device

(76) Inventor: Goro Katsuyama, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/554,396

(22) PCT Filed: Apr. 23, 2004
(86) PCT No.: PCT/JP04/05933

§ 371 Date: Oct. 24, 2005

(30) Foreign Application Priority Data
Apr. 25, 2003 (JP) 2003-120963

(51) Int. Cl. G03G 15/08

(52) U.S. Cl. 399/258; 399/262

(57) ABSTRACT

A storage container includes a bag member made of soft material and configured to store a predetermined substance. A fold is provided on the bag member, and the bag member deforms into a predetermined shape and reduces in volume along the fold, when external pressure is applied to the bag member, when internal pressure of the bag member reduces, or when volume of the stored substance reduces. A grasp guiding unit guides a user about a position of grasping the bag member, and is provided on an outer peripheral surface of the bag member.

### TECHNICAL FIELD

The present invention relates to a storage container and an image forming apparatus, and, more particularly to a storage container that stores matter such as powder, liquid, or gas, and to an image forming apparatus such as a copying machine, a printer, or a facsimile machine that use the storage container.

### BACKGROUND ART

Storage containers are employed in various technical fields. In the field of an image forming apparatus such as a copying machine, for example, Patent Document 1 discloses a storage container. This storage container is a toner storage container (storage container) that stores toners to be supplied to a developing device. The toner storage container, which consists of a bag-shaped soft material, can be shrunk or reduced in volume by a suction force of a screw pump. The toner storage container in the form of a hard bottle such as a cartridge or a bottle is not deformed, and the size thereof remains the same as that before use even after it is used. However, the volume of the toner storage container disclosed in the Patent Document 1, by contrast, reduces after use. Therefore, it is easier for a user to handle this toner storage container than the toner storage container of the hard bottle type. This toner storage container is not bulky and occupies less area when the used container is recovered after being replaced with a new toner storage container. It is, therefore, possible to reduce cost for transporting the storage container from the user to a manufacturer.

However, the shape of the toner storage container disclosed in the Patent Document 1 after volume reduction is not constant, and is sometimes deformed upon squeezing, as shown in FIG. 7. Thus, reducing the volume of the toner storage container becomes disadvantageous and insufficient in terms of space required to store or transport the used storage container. Moreover, if the shape of the container after the volume reduction is unstable, the storage container appears unattractive to the user. Further, depending on the shape after the volume reduction, the container becomes inconvenient to handle.

To overcome these disadvantages, the applicant of the present invention proposes a toner storage container, as disclosed in Patent Document 2, including a guide member that assists deformation of a bag member so that the bag member can be deformed accurately along a fold formed on the bag member when the bag member is reduced in volume and deformed by reducing internal pressure. The guide member, which is more rigid than the soft bag member, is fixed or detachably attached to a predetermined portion of the bag member or formed integrally with the bag member. With this arrangement, when the volume of the bag member is reduced, deformation of the portion at which the guide member is provided is suppressed, thereby suppressing deformation of an unexpected portion of the bag member. Therefore, the volume-reduced bag member is deformed accurately along the fold into a desired, constant shape. The toner storage container disclosed in the Patent Document 2 can, therefore, further optimize the space required to store or transport the used container, and it is convenient to handle the used container.

Patent Document 1: Japanese Patent Application Laid-Patent Open No. H7-219329

Document 2: Japanese Patent Application Laid-Open No. 2003-43797

However, the conventional technique disclosed in the Patent Document 2 has the following disadvantage. To install the toner storage container before being used, that is, the toner storage container before being reduced in volume into an image forming apparatus, the user grasps the toner storage container. Therefore, depending on a grasping state of the user, the fold formed on the bag member may be deformed by pressure applied thereto when the user grasps the storage container. If the fold is deformed, the toner storage container is not deformed into the desired, constant shape after the volume reduction.

This disadvantage will be explained with reference to a specific example. As shown in FIG. 8, while setting a toner storage container 130 into an image forming apparatus, the user grasps the toner storage container 130 with a discharge port 132 facing downward, and sets the toner storage container 130 into the imaging forming apparatus from above the image forming apparatus. At this time, the user often grasps an upper portion of the toner storage container 130, as shown in FIG. 8. If grasped in this manner, the toner storage container 130 deforms as shown in the drawing, and a fold 131b formed on an upper surface of the toner storage container 130 is wrinkled, and the fold 131b is liable to be deformed. When the toner storage container 130, which is set to the image forming apparatus with the deformed fold 131b is reduced in volume, the container 130 cannot be folded up along the initial fold 131b, and a toner storage unit (bag member) 31 cannot be deformed into a desired, constant shape after the volume reduction.

In the example shown in FIG. 8, because a highly rigid guide member 134 is provided on each side surface of the toner storage container 130, the pressure applied to the toner storage unit 31 due to grasping of the toner storage container 130 by the user is dispersed to some extent in a surface direction of the guide member 134. However, if the guide member 31 is not provided on the toner storage container, a locally high pressure is applied to portions of the container touched by the fingers of the user. Consequently, the side surfaces of the toner storage container become undulated, and the fold 131b on the upper surface is more liable to be deformed, and it is more difficult to deform the toner storage container 130 into the desired, constant shape after the volume reduction.

The instance explained above is only one example. If the user holds the storage container inappropriately, the fold is similarly deformed and the container cannot be deformed into the desired, constant shape after the volume reduction.

Particularly in recent years, the toner storage containers tend to be made larger in size and have become heavier before use, to meet a demand of lengthening a toner replacement cycle. Therefore, the pressure applied to the toner storage container when the user grasps the storage container is also higher. Therefore, the fold formed on the soft bag member is liable to be deformed, and the bag member cannot be deformed into the desired, constant shape after the volume reduction. To enhance toner fluidity and to eliminate unevenness in toner distribution, the user normally grasps and shakes the toner storage container before setting the toner storage container into the image forming apparatus. A pressure applied to the toner storage container during this shaking is higher than that applied simply when the user grasps the container. Due to this, during this shaking, the fold formed on the bag member is more liable to be deformed, thereby making it difficult to deform the bag member into the desired, constant shape after the volume reduction.

The disadvantages that the fold formed on the bag member is deformed by the pressure applied to the toner storage container when the user grasps the storage container, and that the bag member cannot be reduced in volume to have the desired constant shape exist not only in the toner storage container, but also in other storage containers that store various other matter such as powder, liquid, and gas.

The present invention has been achieved in view of the conventional disadvantages. It is an object of the present invention to provide a storage container that can suppress a fold from being deformed even if pressure is applied to the storage container when a user grasps it, and that can be stably reduced in volume to have a desired constant shape, and an image forming apparatus using this storage container.

### DISCLOSURE OF INVENTION

According to one aspect of the present invention, a storage container includes a bag member made of soft material and configured to store a predetermined substance; a fold, provided on the bag member, along which the bag member deforms into a predetermined shape and reduces in volume, due to any one of when external pressure is applied to the bag member, when internal pressure of the bag member reduces, and when volume of the stored substance reduces; and a grasp guiding unit that guides a user about a position of grasping the bag member, and that is provided on an outer peripheral surface of the bag member.

According to this invention, because a bag member that contains the stored matter is soft, the bag member can be reduced in volume by applying the external pressure thereto or reducing the internal pressure thereof. Because the fold is formed on this bag member, the bag member can be deformed along the fold into a constant shape when the volume thereof is reduced. The storage container includes the grasp guiding unit that is provided on an outer peripheral surface of the bag member, and that guides a user to a grasp position so as not to change the initial fold along which the bag member is deformed into a shape different from the constant shape, even if pressure is applied to the bag member due to grasping of the storage container by the user. This grasp guiding unit makes the user grasp an appropriate portion on the outer peripheral surface so as not to deform the fold when the user grasps the unused storage container. It is, therefore, possible to suppress deformation of the fold of the storage container caused by the pressure generated when the user grasps the storage container and handles it.

Moreover, in the storage container according to the present invention, the bag member is a polyhedral member having at least three surfaces, and the fold is formed so that one of the three surfaces on which the fold is formed is bent toward an inside of the bag member.

According to this invention, the bag member is a polyhedral member having three or more surfaces, and the fold is formed so that one of the three surfaces on which the fold is formed is bent toward an inside of the bag member. Thus, a storage container installation space in the apparatus can be saved, which is advantageous in size reduction. The used toner storage container can be made more compact, and the handling convenience is enhanced and the storage space of the storage container can be further optimized.

Furthermore, in the storage container according to the present invention, the grasp guiding unit is a mark to indicate the user of a position of placing a finger at the time of grasping the bag member.

According to this invention, by providing a mark for notifying the user of a position to place the fingers of the user to grasp the storage container, the user can clearly recognize the appropriate grasping position.

Moreover, in the storage container according to the present invention, the mark is any one of a recess and a hole formed in a sheet member that is any one of a sheet member provided on an outer peripheral surface of the bag member and a sheet member formed integrally with the bag member, wherein the sheet member has higher rigidity than the bag member.

According to this invention, a recess or a hole formed in a sheet member is employed as the mark, the sheet member provided on an outer peripheral surface of the bag member or formed integrally with the bag member and having higher rigidity than the bag member. The user can place the finger in the recess or on an edge of the hole. Thus, the finger is less slippery on the storage container, and it is possible to suppress the finger slippage and dropping of the storage container when the user grasps and shakes the storage container or sets the storage container into a container holder. Since the user can grasp the storage container even with low pressure, the fold becomes less liable to be deformed.

Furthermore, in the storage container according to the present invention, the mark is a friction surface having a higher frictional coefficient with respect to the finger of the user than with respect to a surface of the bag member.

According to this invention, even if a friction surface having a higher frictional coefficient with respect to the finger of the user than a frictional coefficient with respect to a surface of the bag member is formed as the mark, the same advantages as those explained above can be achieved.

Moreover, the storage container according to the present invention further includes a deformation assisting unit that assists in deformation of the bag member so that the bag member to be reduced in volume is deformed along the fold.

According to this invention, by providing a deformation assisting unit that assists in deformation of the bag member so that the bag member reduced in volume is bent along the fold, the bag member is bent accurately along the fold during volume reduction and can be stably and finely folded up. It is, therefore, possible to stably achieve the high handling convenience and optimize storage space of the used bag member.

Furthermore, in the storage container according to the present invention, the deformation assisting unit is a rigidity enhancing member that makes a part of the bag member higher in rigidity than other parts of the bag member.

According to this invention, a rigidity enhancing member that makes a part of the bag member more rigid than remaining parts of the bag member is employed as the deformation assisting unit. With this arrangement, when the bag member is reduced in volume, although the less rigid parts are deformed, the more rigid part is not deformed. Therefore, by appropriately arranging the rigidity enhancing member, the bag member can be deformed into the desired, constant shape when being reduced in volume.

Moreover, in the storage container according to the present invention, the bag member includes two flat portions facing each other, and the rigidity enhancing member is a flat plate member fixed to at least a part of the flat portions.

According to this invention, the bag member includes two flat portions facing each other, and a flat plate member that is fixed to at least a part of the flat portions is employed as the rigidity enhancing member. With this arrangement, such a member can be easily manufactured by cutting a plate member or a sheet member, so that the deformation assisting unit can be realized easily at low cost.

Furthermore, in the storage container according to the present invention, the rigidity enhancing member is provided on the outer peripheral surface of the bag member, and the grasp guiding unit is provided on the rigidity enhancing member.

According to this invention, the rigidity enhancing member is provided on the outer peripheral surface, and the grasp guiding unit is provided on the rigidity enhancing member. With this arrangement, the rigidity enhancing member prevents a deformation force, generated by the pressure applied to the storage container when the user grasps the storage container, from being transmitted to the fold. Therefore, the fold 3 is less liable to be deformed and the bag member is deformed into the desired, constant shape when being reduced in volume.

According to another aspect of the present invention, an image forming apparatus that forms an image on a recording material using a consumable substance that is stored in a replaceable storage container, includes the storage container that includes a bag member made of soft material and configured to store a predetermined substance; a fold, provided on the bag member, along which the bag member deforms into a predetermined shape and reduces in volume, due to any one of when external pressure is applied to the bag member, when internal pressure of the bag member reduces, and when volume of the stored substance reduces; and a grasp guiding unit that guides a user about a position of grasping the bag member, and that is provided on an outer peripheral surface of the bag member.

According to this invention, employing the above storage container as a replaceable storage container that stores consumable substance at an image forming step enhances the handling convenience and optimizes the storage space of the used storage container replaced with a new one by the user.

Moreover, in the image forming apparatus according to the present invention, the consumable substance is a toner.

According to this invention, by employing the above storage container as a replaceable storage container that stores consumable substance at the image forming step enhances the handling convenience and optimizes the storage space of the used toner storage container when replaced by the user with a new one.

### BRIEF DESCRIPTION OF DRAWINGS

FIGS. 1A and 1B are views to explain a configuration of a toner storage container according to an embodiment of the present invention, where FIG. 1A is a perspective view of the toner storage container before being used, with toner filled up therein, and FIG. 1B is a perspective view of the toner storage container after being used, in which the toner in the toner storage container is consumed; FIG. 2 is a schematic configuration of surroundings of a toner supplying device of a printer; FIGS. 3A to 3C are views to explain a configuration of the toner supplying device according to the embodiment, where FIG. 3A illustrates an external configuration of a nozzle provided in the toner supplying device, FIG. 3B is a cross section of the nozzle in an axial direction, and FIG. 3C is a cross section taken along symbols A-A shown in FIG. 3B; FIG. 4 is a cross section of a screw pump provided in the toner supplying device; FIGS. 5A and 5B are examples of a guide member provided in the toner storage container, where FIG. 5A is a cross section of one example of the guide member provided in the toner storage container, and FIG. 5B is a cross section of another example of the guide member; FIG. 6 is a perspective view of the toner storage container when grasped by a user; FIG. 7 is a perspective view of a conventional toner storage container after being used, in which the toner is consumed; and FIG. 8 is a perspective view of the conventional toner storage container provided with a guide member, grasped by the user.

### BEST MODE(S) FOR CARRYING OUT THE INVENTION

Exemplary embodiments of the present invention will be explained in detail below with reference to the accompanying drawings.

One embodiment of applying the present invention to a printer, which is an electro-photographic image forming apparatus, will be explained. In this embodiment, a monochrome image forming apparatus that performs development using a single developing device will be explained as an example.

A configuration and an operation of the printer according to this embodiment will be explained first.

FIG. 2 is a schematic configuration of surroundings of a developer or toner supplying device serving as a developer transfer device in the printer according to the present embodiment. Similar to an ordinary electro-photographic process, in this printer, a charger (not shown) charges a photosensitive drum 1 serving as a latent image bearing member, with predetermined charges. An exposure unit (not shown) irradiates the charged photosensitive drum 1 with a light according to an image, thereby forming an electrostatic latent image on the photosensitive drum 1. A developing device 10 develops the electrostatic latent image on the photosensitive drum 1 with toners, thereby forming a toner image on the photosensitive drum 1. The toner image formed on the photosensitive drum 1 is then transferred onto a transfer sheet (not shown) serving as a recording material, and fixed onto the transfer sheet by a fixing device, and an image is output.

The developing device 10, which is a so-called two-component developing device, uses the developer in which toners and a carrier are mixed together. The developer stored in the developing device 10 is stirred by two transport screws 11a and 11b while being circulated within a space partitioned by a partitioning member 10a. The developer transported to neighborhoods of a developing roller 12 serving as a developer bearing member is held onto a surface of the developing roller 12 by a magnetic force action of a magnet (not shown) provided within the developing roller 12. The developer held onto the surface of the developing roller 12 is controlled by a doctor blade to have a predetermined layer thickness, following rotation of the developing roller 12, and is used to develop the electrostatic latent image on the photosensitive drum 1 at a position facing the photosensitive drum 1.

During development by the developing device 10, only toners adhere to the electrostatic latent image on the photosensitive drum 1, and the toners in the developer are consumed whenever the development is performed. Therefore, according to this embodiment, the printer is configured to perform the development while the toner supplying device 20 supplies the toners little by little from a toner supply port 14 in order to maintain the amount of toner in the developer used by the developing device 10.

A configuration of the toner supplying device 20 according to this embodiment will be explained next.

The toner supplying device 20 includes a screw pump 23 coupled with the toner supply port 14 of the developing device 10, and a transport tube 21 connected to the screw pump 23 and serving as a developer transport path. The transport tube 21 to be used is preferably made of a rubber material, such as polyurethane, nitrile, or EPDM, which is flexible and excellent in toner resistance. The toner supplying device 20 also includes a container holder 22 that supports a toner storage container 30. The container holder 22 is made of a highly rigid material such as resin.

The toner storage container 30 includes a toner storage unit 31 that is a bag member made of a soft sheet material, and a mouthpiece 32 that forms a toner discharge port and that is used for discharging the toners, which is a consumable substance stored within the toner storage unit 31. The toner storage unit 31 of the toner storage container 30 is preferably made of a plastic sheet such as a polyethylene sheet, a polyester sheet, or a polyurethane sheet. The toner storage unit 31 may have a single-layer structure or a multilayer structure. A seal 33 made of sponge, rubber, or the like is provided on the mouthpiece 32, and a crisscross incision is formed in this seal 33. By inserting a nozzle 40 of the toner supplying device 20 into this incision, the toner storage container 30 is fixed and connected to the toner supplying device 20. The toner storage container 30 is replaced after the toner is consumed. The toner storage container 30 thus configured can be easily attached and detached, thereby preventing toner leakage during replacement or while in use.

FIG. 3A illustrates an external configuration of the nozzle 40 provided in the toner supplying device 20, FIG. 3B is a cross section of the nozzle 40 in an axial direction, and FIG. 3C is a cross section taken along symbols A-A shown in FIG. 3B. As shown in FIG. 3B, the nozzle 40 has a double-tube structure that includes an inner tube 41, and an outer tube 42 that contains the inner tube 41 therein. An interior of the inner tube 41 is used as a toner channel 41a that serves as a developer transport path for discharging the toners within the toner storage container 30. The toners within the toner storage container 30 are sucked by a suction force of the screw pump 23 and drawn into the screw pump 23 through the toner channel 41a.

FIG. 4 is a cross section of the screw pump 23. The screw pump 23, which is referred to as “uniaxial, eccentric screw pump”, includes a rotor 24 and a stator 25. The rotor 24, which has a spirally twisted circular cross section, and which is made of a hard material, is fitted into the stator 25. The stator 25 is made of a rubber-like soft material, and includes a hole having a spirally twisted elliptic cross section, and the rotor 24 is fitted into this hole. A pitch of a spiral of the stator 25 is twice as long as a pitch of a spiral of the rotor 24. The rotor 24 is connected with a driving motor 26 through a universal joint 27 and a bearing 28, for driving the rotor 24 in a rotation.

With this configuration, the toners transported from the toner storage container 30 through the toner channel 41a of the nozzle 40 and the transport tube 21 enter the screw pump 23 from a toner suction port 23a. The toners then enter a space formed between the rotor 24 and the stator 25, and are transported and drawn in a right direction in FIG. 2 due to the rotation of the rotor 24. The toners, having passed through the space between the rotor 24 and the stator 25, are dropped downward from a toner drop port 23b and supplied into the developing device 10 through the toner supply port 14.

As shown in FIG. 3B, the nozzle 40 of the toner supplying device 20 includes an air channel 44 serving as an air supply channel between the inner tube 41 and the outer tube 42. As shown in FIG. 3C, the air channel 44 is configured as two channels 44a and 44b independent of each other, and each having a semicircular cross section. As shown in FIG. 2, the respective air channels 44a and 44b are connected to air pumps 60a and 60b that serve as separate gas transmission devices, through air supply paths 61a and 61b that serve as gas supply channels, respectively. The air pumps 60a and 60b may be ordinary diaphragm air pumps. The air transmitted from the air pumps 60a and 60b is supplied into the toner storage container 30 through the air channels 44a and 44b from air supply ports 46a and 46b that serve as gas supply ports of the respective air channels. The air supply ports 46a and 46b are located below a toner discharge port 47 serving as a developer discharge port of the toner channel 41a, as shown in FIG. 3B. With this configuration, the air supplied from the respective air supply ports 46a and 46b is supplied to toners near the toner discharge port 47. Even if the toners are left unused for a long period of time and clog in the toner discharge port 47, the toners that block the toner discharge port 47 can be unclogged.

The air supply paths 61a and 61b include open/close valves 62a and 62b, respectively, serving as closing units that are opened or closed in response to a control signal from a controller (not shown) serving as a gas transmission controller. The open/close valves 62a and 62b open upon receiving an ON signal from the controller to pass the air, and close upon receiving an OFF signal from the controller to stop passing the air.

An operation of the toner supplying device 20 according to this embodiment will be explained next.

The controller starts a toner supply operation upon receiving a signal from the developing device 10 indicating that a toner density is insufficient. In this toner supply operation, the controller drives the air pumps 60a and 60b to supply the air into the toner storage container 30, and also drives the driving motor 26 of the screw pump 23 to suck and transport the toners. If the air is fed from the air pumps 60a and 60b, the air enters the air channels 44a and 44b of the nozzle 40 from the air supply paths 61a and 61b, and is supplied from the air supply ports 46a and 46b into the toner storage container 30. This air stirs the toners within the toner storage container 30 to encapsulate much air therein, thereby accelerating fluidization of the toners.

If the air is supplied into the toner storage container 30, an internal pressure of the toner storage container 30 increases. Accordingly, a pressure difference is generated between the internal pressure of the toner storage container 30 and an external pressure (atmospheric pressure), and a force for moving in a direction attracted by the pressure acts on the fluidized toners. The toners within the toner storage container 30 are, therefore, discharged in the pressure attracting direction, i.e., from the toner discharge port 47. In this embodiment, not only the former force but also the suction force generated by the screw pump 23 acts on the toners to discharge the toners from within the toner storage container 30 through the toner discharge port 47.

The toners thus discharged from the toner storage container 30 through the toner discharge port 47 pass through the toner channel 41a of the nozzle 40, and move into the screw pump 23 through the transport tube 21. After moving inside the screw pump 23, the toners are dropped downward from the toner drop port 23b and supplied into the developing device 10 through the toner supply port 14. When supply of the toners in a certain quantity is complete, the controller stops driving the air pumps 60a and 60b and the driving motor 26, closes the open/close valves 62a and 62b, thereby finishing the toner supply operation. Closing the open/close valves 62a and 62b at the end of the toner supply operation prevents backflow of the toners into the toner storage container 30 toward the air pumps 60a and 60b through the air channels 44a and 44b of the nozzle 40.

The amount of air supplied from the air pumps 60a and 60b is set to be less than the amount of the toners sucked and the air sucked by the screw pump 23. Therefore, if the toners are consumed, the internal pressure of the toner storage container 30 gradually reduces accordingly. Because the toner storage unit 31 of the toner storage container 30 according to this embodiment is made of soft sheet material, the volume of the toner storage container 30 reduces as the internal pressure reduces.

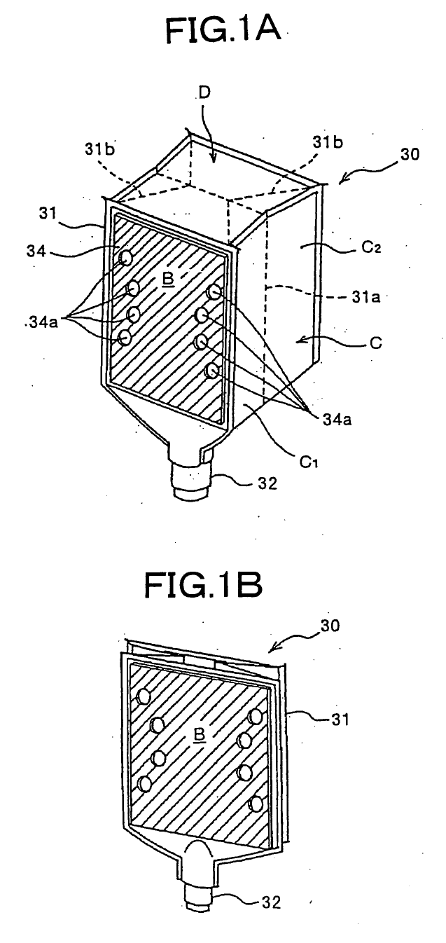

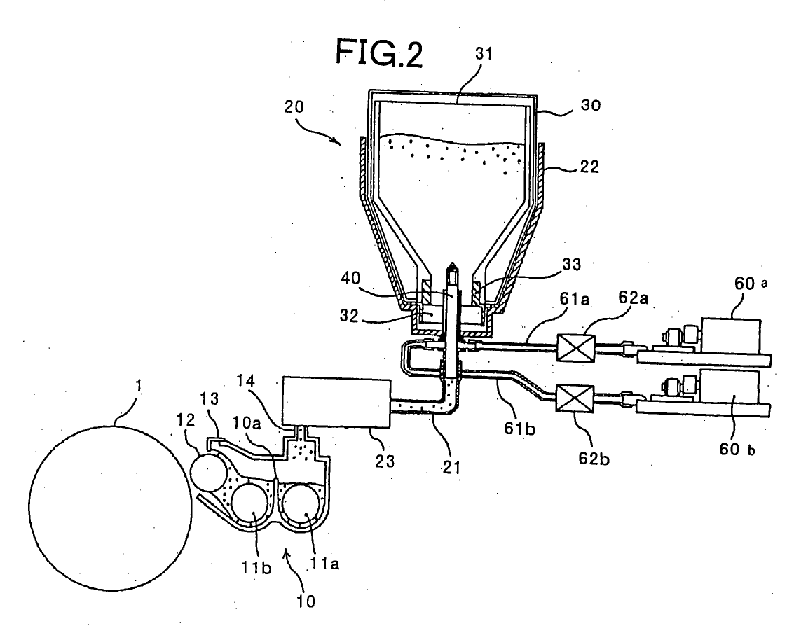

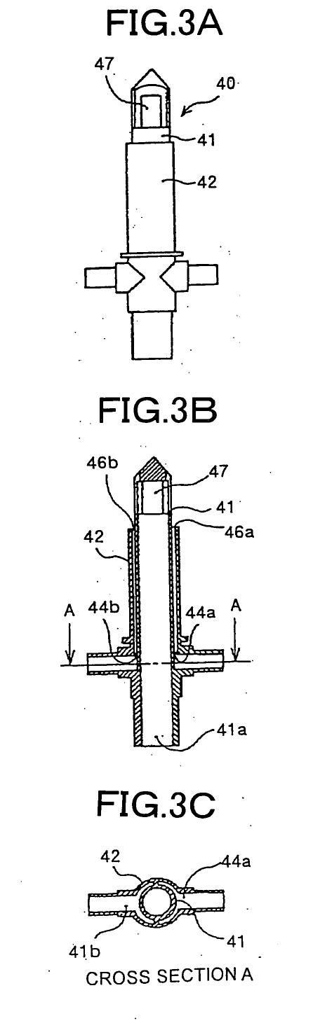

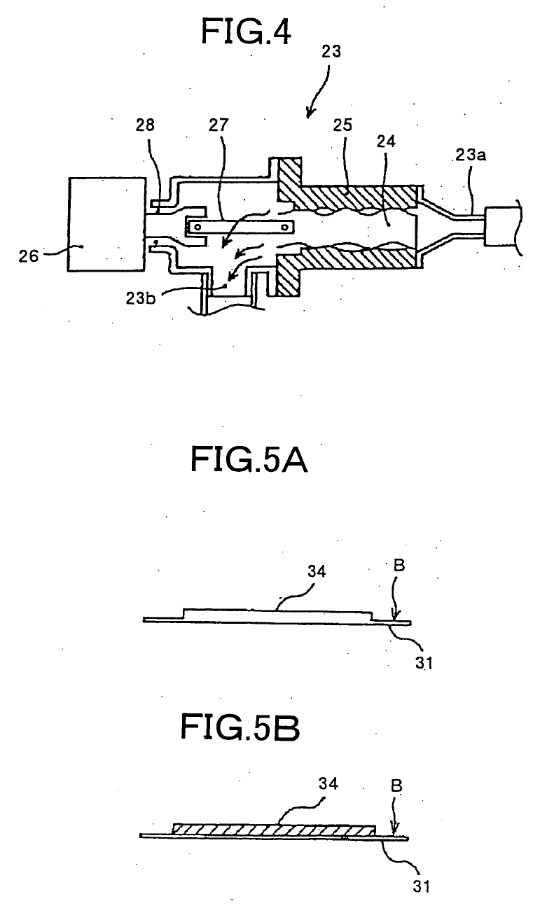

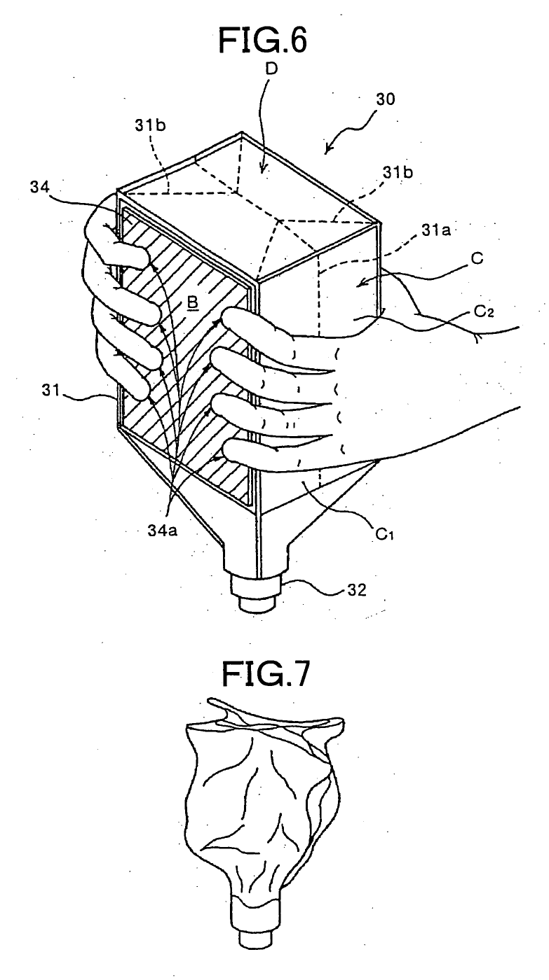

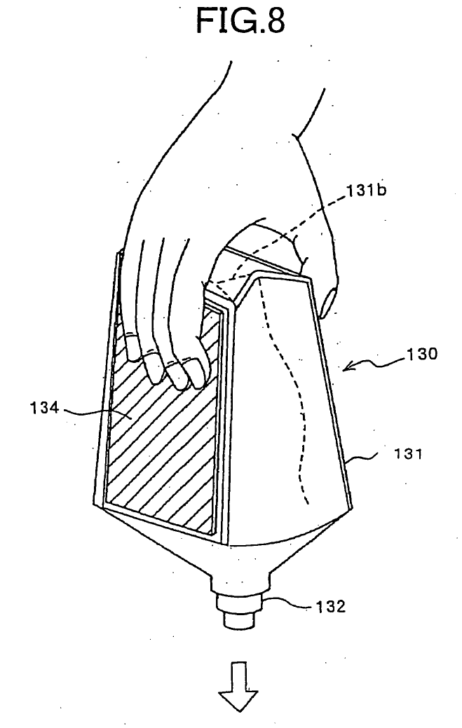

FIGS. 1A and 1B are external views of an example of the toner storage container 30 according to this embodiment. FIG. 1A depicts the toner storage container 30 before being used, with toner filled up therein, and FIG. 1B depicts the toner storage container 30 after being used, in which the toners are consumed. The toner storage unit 31 of the toner storage container 30 is formed by thermally bonding together, at least two layers of the sheet material consisting of polyethylene telephthalate (PET) and polyethylene. The mouthpiece 32 is fixed to the toner storage unit 31 by fusion bonding. It is preferable to fix the mouthpiece 32 to the toner storage unit 31 by fusion bonding so as to ensure good sealing performance. Alternatively, the toner storage container 30 can be formed by any other method.

As shown in FIG. 1A, the toner storage unit 31 is a polyhedron that includes two first flat portions B facing each other, two second flat portions C facing each other and coupling the first flat portions B, and a third flat portion D facing the mouthpiece 32. A fold 31a is formed on each of the second flat portions C so that the two first flat portions B can be made to touch each other in a parallel direction, when the toner storage container 30 reduces in volume and is deformed. This fold 31a is formed so that the second flat portion C bends toward an inside of the toner storage unit 31. Likewise, a fold 31b is formed on the third flat portion D so that the two first flat portions B can be made to touch each other in a parallel direction, when the toner storage container 30 reduces in volume and is deformed. The fold 31a is formed so that the third flat portion D bends toward the inside of the toner storage unit 31.

Alternatively, the folds 31a and 31b may be formed so that the respective flat portions C and D are bent toward the outside of the toner storage unit 31. However, in this embodiment, if the toner storage container 30 gradually reduces in volume when the toners are consumed, the flat portions C and D protrude outside of the toner storage unit 31. Therefore, if the folds are formed in the latter manner, it is necessary to secure a space within the printer so that the flat portions C and D can protrude outside the toner storage unit 31. By forming the folds 31a and 31b so that the flat portions C and D are bent toward the inside of the toner storage unit 31 as explained in this embodiment, even if the toner storage container 30 reduces in volume and is deformed, the second flat portions C and the third flat portion D are folded up inside the toner storage unit 31. Therefore, a projection area of the toner storage container 30 viewed from a normal direction of the first flat portion B is equal in the unused state of the toner storage container 30 with the toners filled up therein, and the used state of the toner storage container 30 in which the toners are consumed and the volume of the toner storage container 30 reduces. Accordingly, the space of the toner storage container after use occupied within the printer does not widen in a surface direction of the first flat portion B. Therefore, space required within the printer to set the toner storage container can be saved, which is advantageous in size reduction. Thus, the used toner storage container 30 can be made more compact, and the handling convenience and the storage space of the toner storage container 30 can be further optimized.

If the toner storage container 30 is to be reduced in volume, it is possible that an uneven pressure is applied to the first flat portions B of the toner storage unit 31. The first flat portions B of the soft toner storage unit 31 are often deformed, e.g., bent or undulated. If such a deformation occurs, for example, sides of the first flat portions B adjacent to the second flat portions C may get curved or bent, and the fold 31a formed on each second flat portion C may be deformed. Consequently, when the toner storage unit 31 is reduced in volume and deformed, the second flat portions C cannot be accurately folded up inside the toner storage unit 31. If the sides of the first flat portions B adjacent to the third flat portion D are curved or bent due to deformation of the first flat portion B, for example, the fold 31b formed on the third flat portion D is deformed. In this case, similar to the above case, if the toner storage unit 31 is reduced in volume and deformed, the third flat portion D cannot be accurately folded up inside the toner storage unit 31.

Therefore, according to this embodiment, a guide member 34 that is a rigidity enhancing member serving as a deformation assisting unit to assist in deformation of the toner storage unit 31, is provided on each outer peripheral surface of the toner storage container 30 so that the volume-reduced toner storage unit 31 can be accurately bent along the folds 31a and 31b. The guide member 34 is flat and is provided on each of the two first flat portions B. The guide member 34 may be made of thick paper, a thin plastic sheet, or the like, and is higher in rigidity than the material for the toner storage unit 31. As shown in FIG. 5A, the guide member 34 may be formed as a part of the material for the toner storage unit 31. Namely, the guide member 34 is formed by making a part of the sheet material of the toner storage container 30 thicker than the other parts. This thicker portion functions as the guide member 34. Alternatively, as shown in FIG. 5B, the guide member 34 may be formed with a sheet material different from the sheet material used for the toner storage container 30, or a plate material. In this case, the guide member 34 is fixed at a predetermined position on the outer peripheral surface of the toner storage container 30 by either adhesive bonding or fusion bonding, and covers an entire surface of each first flat portion B in this embodiment. The guide member 34 may be detachably attached to the toner storage unit 31.

The guide members 34 functions to keep the first flat portions B of the toner storage unit 31 flat while the toner storage unit 31 is reduced in volume, and can therefore prevent the first flat portions B from being wrinkled or undulated during the volume reduction. Thus, the folds 31a and 31b of the second flat portions C and the third flat portion D are not deformed during the volume reduction. When the toner storage unit 31 is reduced in volume and deformed, the respective flat portions C and D are accurately folded up inside the toner storage unit 31. Consequently, when the used toner storage container 30 in which the toners are consumed is to be replaced by a new toner storage container, the used toner storage container 30 removed by the user from the container holder 22 of the toner supplying device 20 is accurately folded up and becomes a flat state as shown in FIG. 1B. During replacement of the toner storage container with a new one, therefore, the user can remove this flat toner storage container 30 from the container holder 22 only by lightly picking up the toner storage container 30 using the fingers. This makes the handling of the used container easy for the user. Because the used toner storage container 30 is flat, the space required for storing or transporting the container 30 can be optimized.

In this embodiment, because the toner storage unit 31 is formed by thermally bonding the sheet member, all the flat portions B, C, and D are identical in material and thickness. With this configuration, manufacturing cost of the toner storage unit 31 reduces. Alternatively, the flat portions B, C, and D may be made from different materials with different thickness. If the flat portions are made from different materials, it is desirable to set the rigidity of the material in decreasing order starting with the first flat portion B, the second flat portion C, and the third flat portion D. Namely, desirable, the third flat portion D is the softest and the first flat portions B are the hardest. With this configuration, the toner storage unit 31 can be smoothly deformed when being bent along the folds 31a and 31b during the volume reduction.

When the toner storage container 30 is replaced, the user must remove the used toner storage container 30 from the container holder 22 and then set the new unused toner storage container 30 into the container holder 22. At this time, the user performs a setting operation while grasping a part of the toner storage unit 31 of the unused toner storage container 30. Depending on the way the user grasps the toner storage unit 31, the pressure applied by grasping may be applied to the toner storage unit 31 such that the folds 31a and 31b formed on the toner storage unit 31 are deformed. The toner storage container 30 according to this embodiment, in particular, is made larger in size than the conventional toner storage container and a weight thereof may be up to one kilogram. Therefore, the pressure applied to the toner storage unit 31 when the user grasps it is higher than that applied to the toner storage unit of the conventional container, with the result that the folds 31a and 31b are more liable to be deformed. In order to secure the fluidity of the toners stored in the toner storage container 30, the user normally shakes the unused toner storage container 30 by hand before setting. The pressure applied to the toner storage unit 31 during shaking is higher than that applied when the user simply grasps the toner storage container 30. The folds 31a and 31b are particularly liable to be deformed during shaking. If the toner storage container 30, in which the folds 31a and 31b are deformed by shaking, is set to the container holder 22, the toner storage unit 31 cannot be bent along the initial folds 31a and 31b during the volume reduction and cannot be deformed into the desired, constant shape after the volume reduction.

According to this embodiment, therefore, a plurality of holes 34a which are marks serving as grasp guiding units are provided in each guide member 34 serving as the sheet member. The holes 34a are intended to guide the user to an appropriate grasp position so that the user can grasp the toner storage unit 31 appropriately. Specifically, the holes 34a are formed at positions such that the folds 31a and 31b do not deform into a shape that deforms the volume-reduced toner storage unit 31 into an unexpected shape even if the pressure generated when the user grasps the toner storage unit 31 is applied to the toner storage unit 31. Each hole 34a is formed at a position at which a finger of the user touches when the user appropriately grasps the toner storage unit 31 so as not to deform the folds 31a and 31b.

With this configuration, according to this embodiment, the user can grasp the toner storage container 30 by placing the respective fingers into the holes 34a, as shown in FIG. 6. In this embodiment, when the user grasps the toner storage container 30 by both hands, the holes 34a corresponding to four fingers from the forefinger to the little finger are formed in the guide member 34 provided on the front-side first flat portion B, as shown in FIG. 6. The hole 34a corresponding to the thumb when the user grasps the toner storage container 30 by both hands is formed in the guide member 34 provided on the rear-side first flat portion B (not shown in FIG. 6). By providing the holes 34a corresponding to the respective fingers, a grasping state of the toner storage container 30 can be kept constant. Thus, it is possible to prevent the toner storage container 30 from being set to the container holder 22 of the printer in a wrong setting state (state in which positions of the two first flat portions B are inverted), as long as the position of the user with respect to the printer when setting the toner storage container 30 to the printer is constant. Alternatively, the holes 34a may be formed at the same positions in the guide members 34 on both the first flat portions B. In this case, the two guide members 34 provided on the respective flat portions B could be configured identical in structure, to reduce manufacturing cost.

According to this embodiment, the toner storage container 30 has a configuration such that the fingers are less slippery on the toner storage unit 31, because the fingers of the user are caught in the respective holes 34a when grasping the toner storage container 30. Therefore, it is possible to suppress finger slippage and dropping of the toner storage container 30 when the user grasps and shakes the toner storage container 30 or sets the toner storage container 30 into the container holder 22. Because the fingers can be placed in the holes 34a, the user can grasp the toner storage container 30 properly even with low pressure. Accordingly, the pressure applied to the toner storage unit 31 during grasping by the user can be reduced, and the folds 31a and 31b can be made less liable to be deformed.

According to this embodiment, the holes 34a formed in the guide member 34 are employed as marks for notifying the user of the positions of placing the fingers to grasp the toner storage unit 31. The same advantages can be achieved even if a configuration other than that including the holes 34a is adopted. For example, the same advantages can be achieved with a configuration in which recesses or protrusions, such that the fingers can be caught therein, are formed at the same positions as those of the respective holes 34a. Alternatively, the same advantages can be achieved even with a configuration in which friction surfaces for preventing finger slippage, having high frictional coefficients relative to the fingers of the user are formed as the respective marks. For example, many fine protrusions may be formed on the surface of each guide member 34 or less slippery rubbers may be bonded on the surface. In this case, the same positions as those of the holes 34a may be classified by color. Alternatively, the many fine protrusions may be formed thereon or less slippery rubbers may be bonded thereon only at the same positions as those of the holes 34a, respectively.

According to this embodiment, although the toner storage container 30 is designed to be grasped by the user by both hands because of its large size, if the toner storage container 30 is small and can be grasped by the user with one hand, the marks such as the holes 34a may be formed so that the user can appropriately grasp the toner storage container 30 by one hand.

The printer according to the present invention includes the toner storage container 30 serving as a storage container that includes the toner storage unit 31 as a soft bag member, which stores toners. The toner storage unit 31 is reduced in volume and deformed into a constant shape along the folds 31a and 31b by applying the external pressure, or by reducing the internal pressure. The toner storage container 30 includes the holes 34a serving as the grasp guiding units that are provided on the outer peripheral surface of the toner storage unit 31, and that guide the user to grasp positions so as not to change the folds 31a and 31b along which the toner storage unit 31 is deformed into a shape different from the constant shape, even if a pressure is applied to the toner storage unit 31 when the user grasps the toner storage container 30. This enables the user to grasp appropriate portions on the outer peripheral surface so as not to deform the folds 31a and 31b at handling time, when the user shakes the toner storage container 30 or sets the toner storage container 30 into the container holder 22. It is, therefore, possible to suppress deformation of the folds of the storage container due to the pressure generated when the user grasps the toner storage container 30 and handles it. The toner storage unit 31 can be stably reduced in volume into the desired, constant shape during the volume reduction.

According to this embodiment, the toner storage unit 31 is a polyhedral member having three or more surfaces, and the folds 31a and 31b are formed so that the second flat portions C and the third flat portion D on which the folds are formed are bent toward the inside of the toner storage unit 31. This configuration saves the installation space for the toner storage container 30 in the printer, which is advantageous in size reduction. The used toner storage container 30 can be made more compact, and the handling convenience and the space required for storing the toner storage container 30 can be further optimized.

According to this embodiment, the holes 34a serving as the grasp guiding units function as marks for notifying the user of positions to place the fingers when the user grasps the toner storage unit 31. Thus, the user can clearly recognize the appropriate grasp positions.

According to this embodiment, the marks are recesses or holes 34 formed in the guide member 34, which is the sheet member provided on the outer peripheral surface of the toner storage unit 31 or formed integrally with the toner storage unit 31, and which is higher in rigidity than the toner storage unit 31. With this configuration, the user can place the fingers in the recesses or edges of the holes 34. The fingers are less slippery on the toner storage unit 31, so that it is possible to suppress finger slippage and dropping of the toner storage container 30 when the user grasps and shakes the toner storage container 30 or sets the toner storage container 30 to the container holder 22, as already explained. Because the user can grasp the toner storage container 30 properly even with low pressure, the folds 31a and 31b are less liable to be deformed. As already explained in the embodiment, even if the marks are friction surfaces, each having a higher frictional coefficient with respect to the finger of the user than a frictional coefficient with respect to a surface of the toner storage unit 31, the same advantages as those explained above can be achieved.

According to this embodiment, the guide member 34 serves as the deformation assisting unit that assists in deformation of the toner storage unit 31, so that the toner storage unit 31 reduced in volume is bent along the folds 31a and 31b. Thus, the toner storage unit 31 can be bent accurately along the folds 31a and 31b during the volume reduction and can be stably and finely folded up. It is, therefore, possible to stably achieve enhanced handling convenience and optimize storage space of the used toner storage container 30.

According to this embodiment, the guide member 34 serving as the deformation assisting unit functions as the rigidity enhancing member that makes a part of the toner storage unit 31 higher in rigidity than remaining parts of the toner storage unit 31. When the toner storage unit 31 is reduced in volume, although the less rigid parts are deformed, the more rigid part is not deformed. Therefore, by appropriately arranging the guide member 34, the toner storage unit 31 can be deformed into the desired, constant shape when being reduced in volume.

According to this embodiment, the toner storage unit 31 includes the two first flat portions B facing each other, and the guide member 34 is configured by a flat plate member fixed to at least a part of the first flat portions B. Such a guide member 34 can be easily manufactured by cutting a plate member or a sheet member, so that the deformation assisting unit can be realized easily at low cost.

According to this embodiment, the holes 34 are provided in the guide member 34. Therefore, the guide member 34 can prevent a deformation force, which is generated by the pressure applied to the toner storage unit 31 when the user grasps the toner storage unit 31, from being transmitted to the folds 31a and 31b. Thus, the folds 31a and 31b are less liable to be deformed and the toner storage unit 31 is deformed into the desired, constant shape when being reduced in volume.

The printer according to this embodiment employs the above storage container as a replaceable storage container that stores toners as consumable substance at an image forming step. It is, therefore, possible to stably enhance the handling convenience and optimize the storage space of the used toner storage container replaced with a new one by the user.

According to this embodiment, the toner storage container 30 is reduced in volume by reducing the internal pressure of the toner storage unit 31 by sucking the toners using the screw pump 23. However, the volume of the toner storage container 30 can be reduced by other configurations. For example, a filter that does not pass through toners and that passes through only the air may be provided on the outer peripheral surface of the toner storage unit 31, so that the internal air of the toner storage unit 31 is sucked through the filter. Alternatively, the volume of the toner storage container 30 may be reduced by applying the external pressure to the toner storage unit 31. In this embodiment, an example in which the volume of the toner storage container 30 is gradually reduced along with the consumption of the toners has been explained. Alternatively, the volume of the toner storage container 30 may not be reduced until the toner storage container 30 is empty and, after the toner storage container 30 is empty, the volume of the toner storage container 30 may be reduced by applying the external pressure thereto, or by reducing the internal pressure thereof after the toner storage container 30 is empty but before the user removes the toner storage container 30.

In this embodiment, the toner storage container 30 in which the toners are stored has been explained. However, the present invention is not limited to the toner storage container, and can be similarly applied to other storage containers that store various matter such as powder, liquid, and gas in other technical fields such as the food field.

According to the embodiment of the present invention, it is possible to suppress deformation of the folds even if the pressure is applied to the storage container due to grasping by the user, and the storage container can be stably reduced in volume and deformed into the desired, constant shape.

### INDUSTRIAL APPLICABILITY

As explained above, the storage container and the image forming apparatus according to the present invention are effectively used as a storage container that stores matter such as powder, liquid, or gas, and as an image forming apparatus such as a copying machine, a printer, or a facsimile machine, that uses this storage container, respectively. The storage container according to the present invention is particularly suitable as an apparatus system that stores supplies such as development toners, that is set to the developing device, and that needs to be replaced and transported when it is emptied, or as a storage container that stores matter such as powder, liquid, or gas used in the food field and the like.

1-12. (canceled)

13. A storage container comprising:
a bag member made of soft material and configured to store a predetermined substance;
a fold, provided on the bag member, along which the bag member deforms into a predetermined shape and reduces in volume, due to any one of when external pressure is applied to the bag member, when internal pressure of the bag member reduces, or when volume of the stored substance reduces; and
a grasp guiding unit that guides a user about a position of grasping the bag member, and that is provided on an outer peripheral surface of the bag member.

14. The storage container according to claim 13, wherein
the bag member is a polyhedral member having at least three surfaces, and
the fold is formed so that one of the three surfaces on which the fold is formed is bent toward an inside of the bag member.

15. The storage container according to claim 13, wherein
the grasp guiding unit is a mark to indicate the user of a position of placing a finger at a time of grasping the bag member.

16. The storage container according to claim 15, wherein
the mark is one of a recess or a hole formed in a sheet member that is one of a sheet member provided on an outer peripheral surface of the bag member or a sheet member formed integrally with the bag member, wherein the sheet member has higher rigidity than the bag member.

17. The storage container according to claim 15, wherein
the mark is a friction surface having a higher frictional coefficient with respect to the finger of the user than with respect to a surface of the bag member.

18. The storage container according to claim 13, further comprising:
a deformation assisting unit that assists in deformation of the bag member so that the bag member to be reduced in volume is deformed along the fold.

19. The storage container according to claim 18, wherein
the deformation assisting unit is a rigidity enhancing member that makes a part of the bag member higher in rigidity than other parts of the bag member.

20. The storage container according to claim 19, wherein
the bag member includes two flat portions facing each other, and
the rigidity enhancing member is a flat plate member fixed to at least a part of the flat portions.

21. The storage container according to claim 19, wherein
the rigidity enhancing member is provided on the outer peripheral surface of the bag member, and
the grasp guiding unit is provided on the rigidity enhancing member.

22. The storage container according to claim 13, wherein
the grasp guiding unit is provided on a largest surface of the bag member.

23. The storage container according to claim 13, wherein
the grasp guiding unit is provided so as not to deform the fold due to pressure exerted when the user grasps the bag member.

24. An image forming apparatus that forms an image on a recording material using a consumable substance that is stored in a replaceable storage container, wherein
the storage container includes
a bag member made of soft material and configured to store a predetermined substance;
a fold, provided on the bag member, along which the bag member deforms into a predetermined shape and reduces in volume, due to any one of when external pressure is applied to the bag member, when internal pressure of the bag member reduces, or when volume of the stored substance reduces; and
a grasp guiding unit that guides a user about a position of grasping the bag member, and that is provided on an outer peripheral surface of the bag member.

25. The image forming apparatus according to claim 24, wherein the consumable substance is a toner.
